(19) United States
(12) Patent Application Publication
(10) Pub. No.: US 2012/0185792 A1
(43) Pub. Date: Jul. 19, 2012

(54) Pictorial Representation Of Patient Condition Trending

(75) Inventors: Gardner Kimm, Carlsbad, CA (US); Peter R. Doyle, Vista, CA (US)

(73) Assignee: Nellcor Puritan Bennett LLC, Boulder, CO (US)

(21) Appl. No.: 13/005,748

(22) Filed: Jan. 13, 2011

(51) Int. Cl. G06F 3/048

(52) U.S. Cl. 715/772

(57) ABSTRACT

The disclosure describes improved systems and methods for displaying a trend history of the patient condition using pictorial representations that dynamically change as the clinician advances and reverses through an independent parameter. The present application displays changes in patient condition as a pictorial instead of a number or waveform. By displaying changes in patient condition in a pictorial, a clinician may be able to quickly understand how the dependent parameters have changed as a function of an independent parameter. As the pictorial changes, it animates from one condition to the next to more effectively indicate changes in patient condition. A representation of the normal or desired condition for a parameter is shown as a static pictorial that is overlaid with the dynamically changing trend. In this manner the clinician can determine how the patient condition is changing relative to a desired state.

### INTRODUCTION

A ventilator is a device that mechanically helps patients breathe by replacing some or all of the muscular effort required to inflate and deflate the lungs. When a patient is undergoing mechanical ventilation, his or her condition is likely to change during the course of treatment. Changes in patient condition are often expressed as raw numerics or waveforms. Oftentimes, the breadth and complexity of change in patient condition renders the raw numerics or waveforms difficult to comprehend and utilize. Furthermore, the raw numerics and waveforms may make it difficult to ascertain trends in the history of a patient's condition. A need exists for an easily understandable manner of conveying trend history of a patient's condition.

### Pictorial Representation of Patient Condition Trending

The disclosure describes improved systems and methods for displaying a trend history of the patient condition using pictorial representations that dynamically change as the clinician advances and reverses through an independent variable parameter. The present application displays changes in patient condition as an animation or series of illustrations instead of or in addition to a changing number or the drawing of a waveform. By displaying changes in patient condition pictorially as an animated series of illustrations or images, a clinician may be able to quickly understand how the dependent parameters have changed as a function of an independent variable parameter. Moreover, a clinician may be able to determine when one parameter is changing in relation to another parameter. As the pictorial representation changes, it animates from one condition to the next to more effectively indicate changes in patient condition. A representation of the normal or desired condition for a parameter is shown as a static illustration that is overlaid with the dynamically changing trend. In this manner the clinician can determine how the patient condition is changing relative to a desired state.

This disclosure describes systems and methods for displaying trend history of a patient's condition on a ventilator. In one embodiment, the disclosure may utilize a graphical user interface to display one or more component elements of a respiratory system. Each component element of the one or more component elements further comprising at least one line outlining the components, wherein thickness of the line corresponds to a numeric value of at least one ventilatory parameter. The graphical user interface further comprises first line having a thickness corresponding to a predetermined reference value of a first ventilatory parameter and a second line, adjacent to the first line, having a thickness corresponding to a measured value of the first ventilatory parameter. An increased thickness of the second line corresponds to an increase in the measured value of the ventilatory parameter. A decreased thickness of the second line corresponds to a decrease in the measured value of the ventilatory parameter. The increase and decrease in line thickness may be measured over an independent variable, such as time.

In another embodiment, the disclosure relates to a method for animating patient trend history on a graphical user interface on a ventilator. The method comprises first displaying a graphical user interface with an original thickness for a first line. The ventilatory parameters are then monitored and a determination is made as to whether ventilatory parameter associated with the first line has changed. If a change is detected the graphical user interface is updated. The graphical user interface is then displayed with a new thickness for the first line.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which from a part of this application, are illustrative of described technology and are not meant to limit the scope of the invention as claimed in any manner, which scope shall be based on the claims appended hereto.

FIG. 1 is a diagram illustrating an embodiment of an exemplary ventilator connected to a human patient.

FIG. 2 is a block-diagram illustrating an embodiment of a ventilatory system having a graphical user interface for displaying trend history of a patient's condition.

FIG. 3 is an illustration of an embodiment of a user interface for pictorially displaying trend history of a patient's condition at a first point in time.

FIG. 4 is an illustration of an embodiment of a user interface for pictorially displaying trend history of a patient's condition at a second point in time.

FIG. 5 is an illustration of an embodiment of a user interface for pictorially displaying trend history of a patient's condition at a third point in time.

FIG. 6 is an illustration of an embodiment of a user interface for pictorially displaying trend history of a patient's condition at a fourth point in time.

FIG. 7 depicts a method for animating patient trend history on a graphical user interface in association with a ventilator.

### DETAILED DESCRIPTION

Although the techniques introduced above and discussed in detail below may be implemented for a variety of medical devices, the present disclosure will discuss the implementation of these techniques for use in a mechanical ventilator system. The reader will understand that the technology described in the context of a ventilator system could be adapted for use with other therapeutic equipment having user interfaces, including graphical user interfaces (GUIs), for improved display of patient parameters.

The present disclosure provides an institution or clinician with optimal control over routine ventilatory settings. Specifically, routine patient trend configuration settings may be preconfigured according to a hospital-specific, clinic-specific, physician-specific, or any other appropriate protocol. Moreover, patient trend configuration settings may be changed and edited in response to a particular patient's changing needs and/or condition.

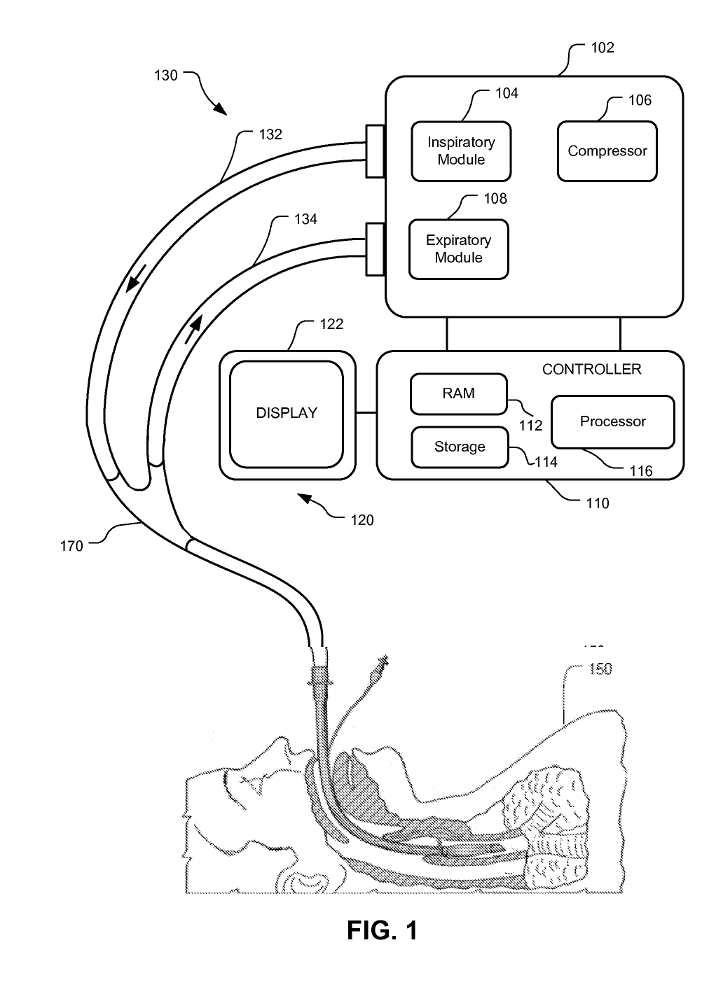

FIG. 1 illustrates an embodiment of a ventilator connected to a human patient 150. The ventilator includes a pneumatic system 102 (also referred to as a pressure generating system 102) for circulating breathing gases to and from patient 150 via the ventilation tubing system 130, which couples the patient to the pneumatic system via an invasive patient interface (e.g., endotracheal tube).

Ventilation tubing system 130 may be a two-limb (shown) or a one-limb circuit for carrying gas to and from the patient 150. In a two-limb embodiment as shown, a fitting, typically referred to as a “wye-fitting” 170, may be provided to couple the patient interface to an inspiratory limb 132 and an expiratory limb 134 of the ventilation tubing system 130. Pneumatic system 102 may be configured in a variety of ways. In the present example, system 102 includes an expiratory module 108 coupled with the expiratory limb 134 and an inspiratory module 104 coupled with the inspiratory limb 132. Compressor 106 or other source(s) of pressurized gases (e.g., air, oxygen, and/or helium) is coupled with inspiratory module 104 to provide a gas source for ventilatory support via inspiratory limb 132.

The pneumatic system may include a variety of other components, including sources for pressurized air and/or oxygen, mixing modules, valves, sensors, tubing, accumulators, filters, etc. Controller 110 is operatively coupled with pneumatic system 102, signal measurement and acquisition systems, and an operator interface 120 that may enable an operator to interact with the ventilator (e.g., reset alarms, change ventilator settings, select operational modes, view monitored parameters, etc.). Controller 110 may include memory 112, one or more processors 116, storage 114, and/or other components of the type commonly found in command and control computing devices.

The memory 112 is computer-readable storage media that stores software that is executed by the processor 116 and which controls the operation of the ventilator. In an embodiment, the memory 112 includes one or more solid-state storage devices such as flash memory chips. In an alternative embodiment, the memory 112 may be mass storage connected to the processor 116 through a mass storage controller (not shown) and a communications bus (not shown). Although the description of computer-readable media contained herein refers to a solid-state storage, it should be appreciated by those skilled in the art that computer-readable storage media can be any available media that can be accessed by the processor 116. Computer-readable storage media includes volatile and non-volatile, removable and non-removable media implemented in any method or technology for storage of information such as computer-readable instructions, data structures, program modules or other data. Computer-readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

As described in more detail below, controller 110 may monitor pneumatic system 102 in order to evaluate the condition of the patient and to ensure proper functioning of the ventilator based on various parameter settings. The specific parameter settings may be based on preconfigured settings applied to the controller 110, or based on input received via operator interface 120 and/or other components of the ventilator. In the depicted example, operator interface 120 includes a display 122 that is touch-sensitive, enabling the display to serve both as an input and output device.

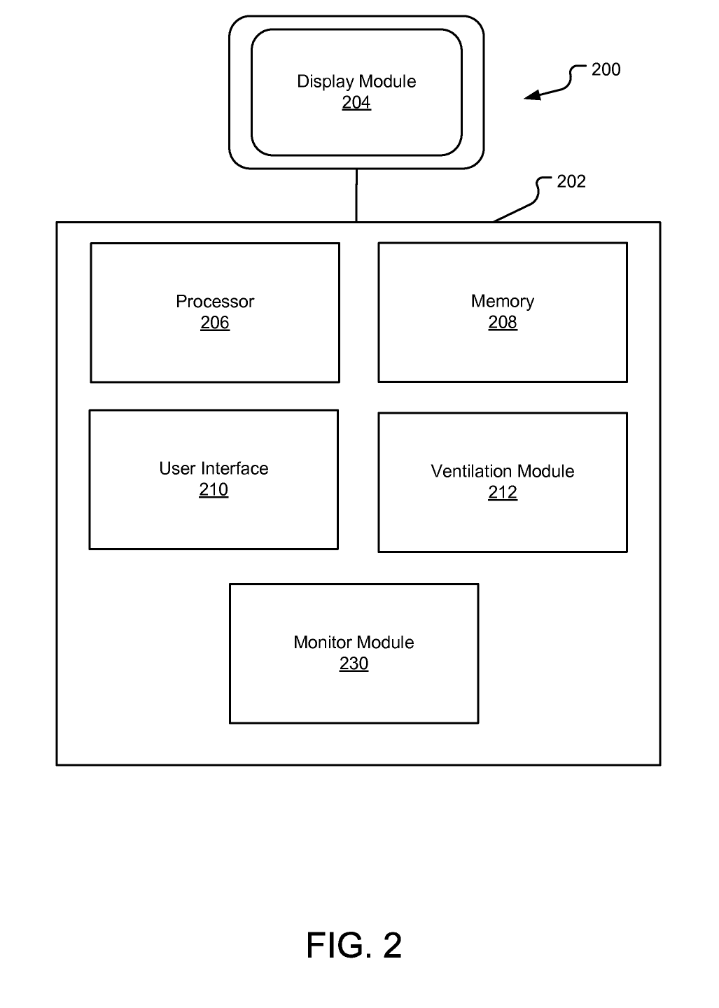

FIG. 2 is a block-diagram illustrating an embodiment of a ventilatory system 200 having a graphical user interface for trend history of a patient's condition.

The ventilator 202 includes a display module 204, memory 208, one or more processors 206, user interface 210, and ventilation module 212. Memory 208 is defined as described above for memory 112. Memory 208 may further may be used to store multiple illustrations, images or pictures for use in presenting the pictorial representation of patient trends and reference bands, as will be discussed in further detail below. Similarly, the one or more processors 206 are defined as described above for the one or more processors 116. Ventilation module 212 may oversee ventilation as delivered to a patient according to the ventilatory settings prescribed for the patient. For example, ventilation module 212 may deliver pressure and/or volume into a ventilatory circuit, and thereby into a patient's lungs, by any suitable method, either currently known or disclosed in the future.

The display module 204 presents various input screens and displays to a clinician, including but not limited to display of trend history of a patient's condition, as will be described further herein. The display module 204 is further configured to communicate with user interface 210. The display module 204 may provide various windows and elements to the clinician for input and interface command operations. Additionally, user interface 210 may accept commands and input through display module 204 and may provide useful trend history information relating to a patient's condition to the clinician through display module 204. Display module 204 may further be an interactive display, whereby the clinician may both receive and communicate information to the ventilator 202, as by a touch-activated display screen. Alternatively, user interface 210 may provide other suitable means of communication with the ventilator 202, for instance by a keyboard or other suitable interactive device.

The monitor module 230 monitors both the independent variable parameter and animated parameters used to provide a trend history of a patient's condition. As will be discussed in further detail below, one or more animated parameters are expressed as a function of the independent variable parameter. The animated parameters are the specific parameters utilized to display a trend history of a patient's condition. The monitor module 230, therefore, is communicatively coupled to the ventilation module 212 to determine values for the independent variable and animated parameters and to determine when an event has occurred, and is further communicatively coupled to display module 204 to provide the with the values necessary to create a trend history of a patient's condition.

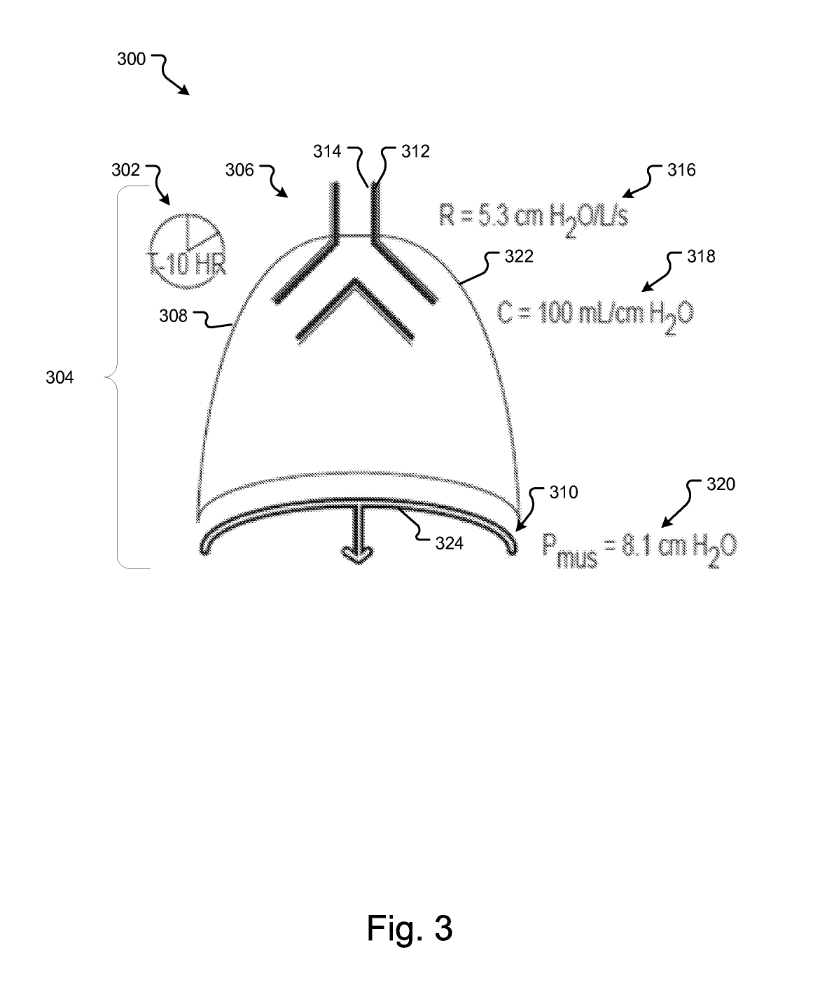

FIG. 3 is an illustration of an embodiment of a pictorial trend user interface 300 for displaying trend history of a patient's condition. As will be discussed in detail below, pictorial trend user interface 300 may be used to depict how a patient's condition has improved or deteriorated in relation to an independent variable. For the purposes of the following discussion regarding FIG. 3-6, the independent variable is time. However, it will be appreciated various parameters may be utilized as the independent variable, such as the monitored parameters such as pressures, volumes or flows and clinician set parameters such as oxygen concentration setting or the positive end expiratory setting.

As discussed above, the independent variable is used to depict trend history of the patient's condition. The patient's condition may be affected by one or more measured parameters. As will be appreciated, any number of parameters may affect the patient's condition including but not limited to resistance, compliance, respiratory muscle pressure, carbon dioxide elimination. For the purposes of this disclosure, parameters that are displayed in pictorial trend user interface 300 are referred to as animated parameters. For example, FIGS. 3-6 include animated parameters of resistance (R), compliance (C), or respiratory muscle pressure (Pₘᵤₛ). These animated parameters will be displayed as a function of the independent variable parameter. As the independent variable parameter in pictorial trend user interface 300 is time, each animated parameter will display the patient measurement for that animated parameter at a given time. In other words, at time 10 hours, the animated parameters of resistance, compliance, and respiratory muscle pressure, are measured at 5.3 cm H₂O/L/s, 100 mL/cm H₂O, and 8.1 cm H₂O respectively.

Pictorial trend user interface 300 may be accessed via any suitable means, for example via a main ventilatory user interface on display module. Pictorial trend user interface 300 may provide one or more independent or embedded windows for display and one or more elements for selection and/or input. Windows may include one or more elements and, additionally, may provide graphical displays, instructions, or other useful information to the clinician. Elements may be displayed as buttons, tabs, icons, toggles, or any other suitable visual access element, etc., including any suitable element for input selection or control.

Pictorial trend user interface 300 may include a parameter display icon 302 for displaying data relating to the chosen independent variable. As discussed above, the parameter used with relation to pictorial trend user interface 300 is time. The parameter display icon 302, as depicted in pictorial trend user interface 300, may display how much time has elapsed since the pictorial trend user interface 300 began monitoring the patient condition. In another embodiment, the parameter display icon 302, may display the amount of time remaining until the pictorial trend user interface 300 ceases monitoring the patient condition. In yet another embodiment, parameter display icon 302 may illustrate the amount of time remaining in an interval for display on pictorial trend user interface 300. For example, parameter display icon 302 displays that 10 hours remain in the patient monitoring interval for display on pictorial trend user interface 300. As will be appreciated, the parameter display icon 302 may be selectable wherein, upon selection, more information regarding the parameter is displayed to a user.

As discussed above, pictorial trend user interface 300 provides a pictorial display of the patient's condition in relation to an independent variable. The pictorial trend user interface 300 may also provide a pictorial display of how a change in one animated parameter affects another animated parameter. The pictorial display may be any symbol, representation, graphic, etc. that provides the user with an illustrative understanding of the patient's condition. In one embodiment, the pictorial display is an illustration of a respiratory system 304. The respiratory system 304 includes multiple components such as airways 306, a lungs 308, and a diaphragm 310. As will be appreciated, the airways 306, lungs 308, and diaphragm 310 are all essential components of a respiratory system as depicted by respiratory system 304.

One or more of the components of respiratory system 304 may include multiple sets of lines outlining the component. For example, in pictorial display user interface 300, the airway 306 includes both a lighter line 312 and a darker, thicker line 314. As will be appreciated, any method of contrasting the lines, such as pattern, color, shape, and use of 3-dimensional effect, may be utilized in the spirit of the present application in lieu of lightness and darkness. In one embodiment, the lighter line 312, represents a reference band, indicating a desirable zone for an animated parameter, and the darker line 314 represents patient measurements. For example, the lighter line 312 represents a reference band indicating the desirable zone for the resistance (R) 316 animated parameter. The desirable zone may be a patient specific or standardized value or range of values. The lighter line 312 may be placed next to the darker line 314 to graphically contrast the reference band with the patient measurements. In one embodiment, the reference band is contrasted with the patient measurements by changing the thickness of the darker line 314. As will be appreciated any method of indication such as pattern, color, and use of 3-dimensional effect, may be utilized in the spirit of the present application in lieu of thickening the lines. If the patient measurements exceed the desirable zone, the darker line 314 may be depicted as thicker than the lighter line 312. On the other hand, if the patient measurements fall below the desirable zone, the darker line 314 may be depicted as thinner than the lighter line 312. In one embodiment, the lines may be laid over one another. For example, the darker line may be displayed as within the lighter line. As depicted with regard to pictorial trend user interface 300, the measured patient resistance (R) 316 animated parameter is 5.3 cm H₂O/L/s. This patient measurement for resistance exceeds the desirable zone as is depicted by the darker line 314 thicker than the lighter line 312.

Components of respiratory system 304 may also be depicted without a reference band. For example, the line 322 outlining lungs 308 relates to the compliance 318 animated parameter. This line 322, however, is not contrasted with a reference band. Likewise, the line 324 outlining diaphragm, which is associated with the respiratory muscle pressure value 320 is also not contrasted with a reference band. However, even though lines 322 and 324 are not displayed adjacent to a reference band, the lines 322 and 324 are still useful in displaying historical trend of patient condition, as will be discussed in further detail below.

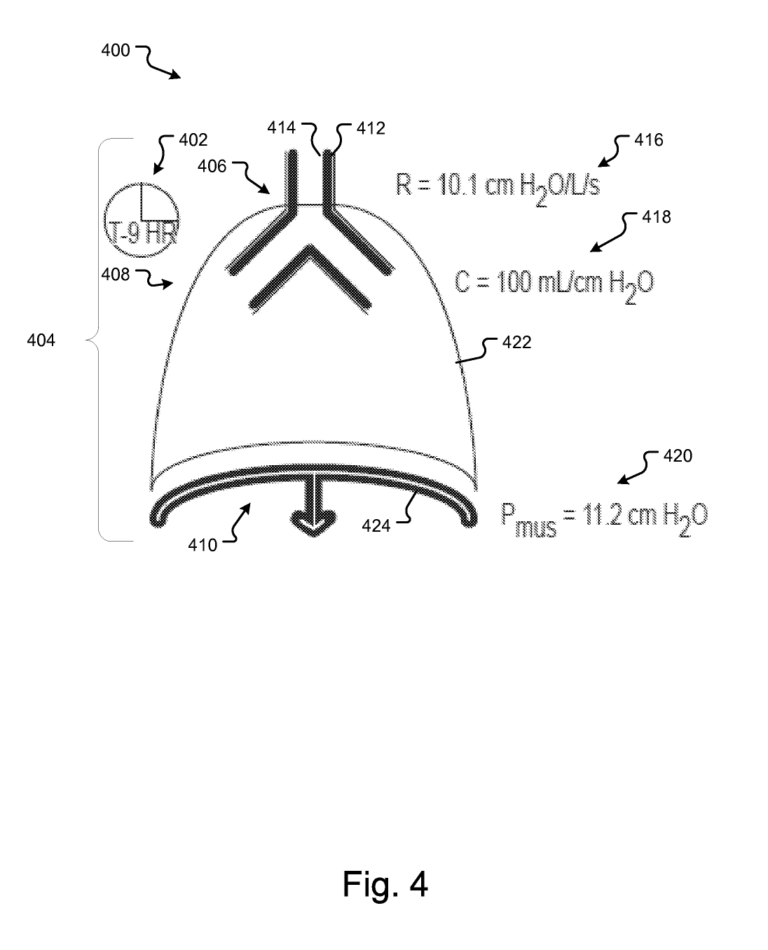

FIG. 4 is an illustration of an embodiment of a pictorial trend user interface 400 for displaying trend history of a patient's condition. Pictorial trend user interface 400 describes like elements of pictorial trend user interface 300. However, pictorial trend user interface 400 depicts patient measurements at time T-9 hours, as depicted by parameter icon 402.

As depicted by pictorial trend user interface 400, at time T-9 hours, the patient's resistance 416 and respiratory muscle pressure 420 have both increased in value while compliance 418 remains the same as at time T-10 hours depicted by pictorial trend user interface 300. Specifically, resistance has increased from 5.3 cm H₂O/L/s to 10.1 cm H₂O/L/s and respiratory muscle pressure has increased from 8.1 cm H₂O to 11.2 cm H₂O. This increase in resistance and respiratory muscle pressure is illustrated by thicker lines 414 and 424 respectively than at time 10 hours. In one embodiment, the change in animated parameters may be accompanied by an audio cue. For example, when the resistance and respiratory muscle pressure increase, the ventilator may emit a wheezing sound.

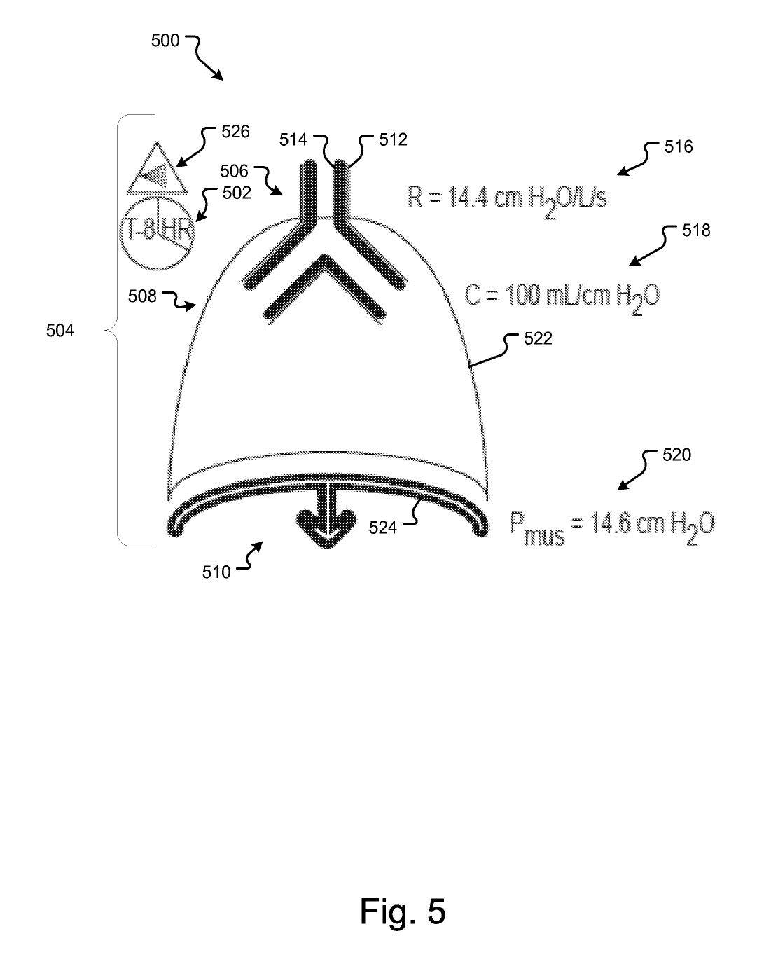

FIG. 5 is an illustration of an embodiment of a pictorial trend user interface 500 for displaying trend history of a patient's condition. Pictorial trend user interface 500 describes like elements of pictorial trend user interfaces 300 and 400. However, pictorial trend user interface 500 depicts patient measurements at time T-8 hours, as depicted by parameter icon 502.

As depicted by pictorial trend user interface 500, at time T-8 hours, the patient's resistance 516 and respiratory muscle pressure 520 have both increased in value while compliance 518 remains the same as at time T-9 hours depicted by pictorial trend user interface 400. Specifically, resistance has increased from 10.1 cm H₂O/L/s to 14.4 H₂O/L/s and respiratory muscle pressure has increased from 11.2 cm H₂O to 14.6 cm H₂O. This increase in resistance and respiratory muscle pressure is illustrated by thicker lines 514 and 524 respectively than at time T-9 hours. In one embodiment, the change in animated parameters may be accompanied by an audio cue. For example, when the resistance and respiratory muscle pressure increase, the ventilator may emit a wheezing sound.

Pictorial trend user interface also includes event marker 526. Event marker 526 is displayed when the patient has undergone a treatment or procedure. For example, event marker 526 may be used to indicate that the patient has received a delivery of aerosol medication. Any number of event markers may be utilized in the spirit of the present application, including but not limited to event markers indicating lung recruitment mechanisms, change in ventilator settings, use of sedatives, suctioning, etc.

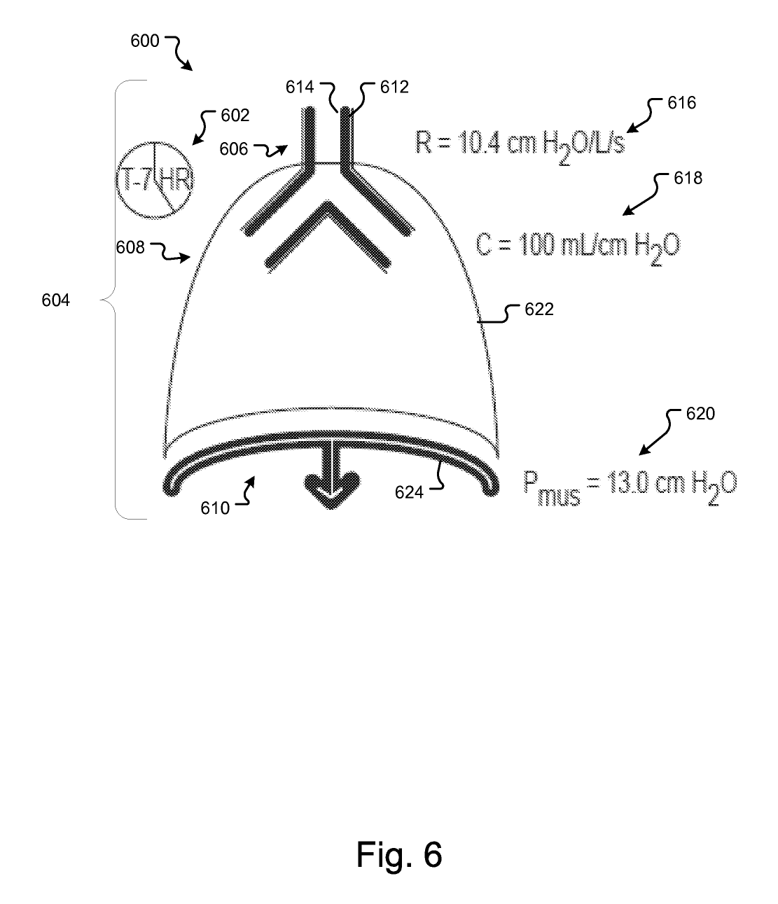

FIG. 6 is an illustration of an embodiment of a pictorial trend user interface 600 for displaying trend history of a patient's condition. Pictorial trend user interface 600 describes like elements of pictorial trend user interfaces 300-500. However, pictorial trend user interface 600 depicts patient measurements at time T-7 hours, as depicted by parameter icon 602.

As depicted by pictorial trend user interface 600, at time T-7 hours, the patient's resistance 616 and respiratory muscle pressure 620 have both decreased in value while compliance 618 remains the same as at time T-8 hours depicted by pictorial trend user interface 500. Specifically, resistance has decreased from 14.4 H₂O/L/s to 10.4 cm H₂O/L/s and respiratory muscle pressure has decreased from 14.6 cm H₂O 13.0 cm H₂O. This decrease in resistance and respiratory muscle pressure is illustrated by thinner lines 614 and 624 respectively than at time T-9 hours. In one embodiment, the change in animated parameters may be accompanied by an audio cue. For example, when the resistance and respiratory muscle pressure decrease, the wheezing sound may subside.

In one embodiment, pictorial trend user interfaces 300-600 may be periodically redrawn to depict real-time patient conditions. For example, pictorial trend user interfaces 300-600 may be redrawn once a minute to reflect real time patient conditions. As will be appreciated, pictorial trend user interfaces may redrawn at any variety of frequencies to reflect real-time patient conditions.

As will be appreciated, in addition to being displayed on a ventilator during the delivery of therapy, the pictorial trend user interfaces 300-600 may be “played” in order. In other words, the pictorial trend user interfaces 300-600 may be displayed sequentially to animate the history trend of the patient's condition. The speed of playback and duration of display may be controlled manually (i.e. via speed of rotation of an input knob) or automatically (i.e. selecting an interval for replay of the trend pictorial). In addition, the pictorial trend user interface can be changed in near real time to depict changes that may be occurring at a faster interval (i.e. from one breath to another). When the pictorial trend user interfaces 300-600 are played back, a user may be provided with a clearer understanding of the patient's condition. For example, the thickening of lines relating to resistance and respiratory muscle pressure in pictorial trend user interfaces 300-500 will indicate that the resistance and respiratory muscle pressure are increasing. Moreover, the thinning of lines relating to resistance and respiratory muscle pressure in pictorial trend user interface 600 may indicate that the resistance and respiratory muscle pressure are decreasing. Furthermore, the played back animation may depict the relationship between animated parameters. For example, in pictorial trend user interfaces 300-500, an increase in resistance might cause an increase in respiratory muscle pressure. In addition, the event marker 526 at pictorial trend user interface 500, may indicate to a user that the reason the resistance and respiratory muscle pressure decreased was because an aerosolized medication was administered to the patient.

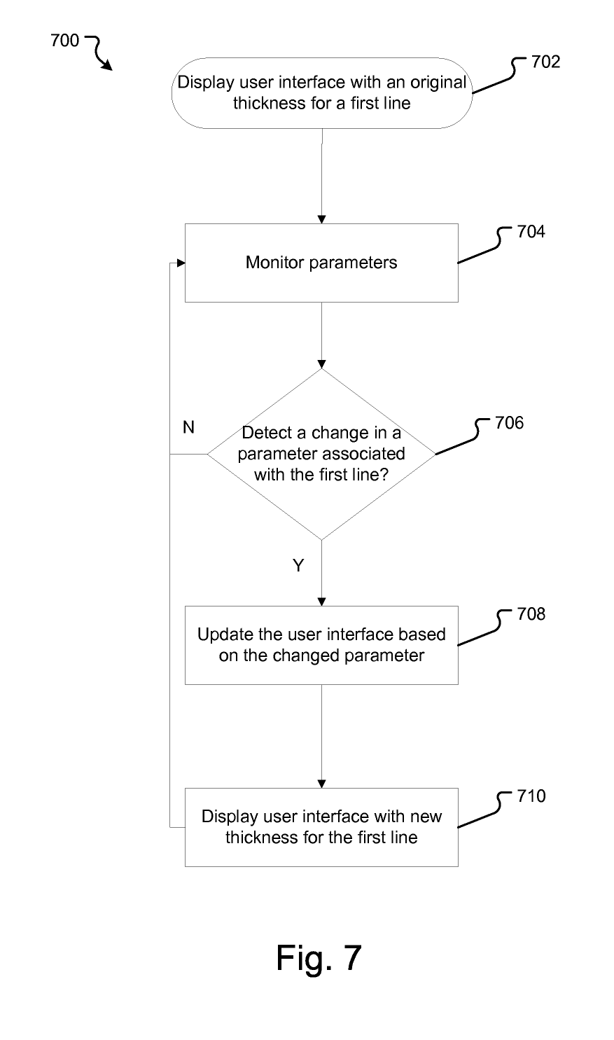

FIG. 7 depicts a method 700 for animating patient trend history on a graphical user interface in association with a ventilator.

At operation 702, a user interface is displayed with an original thickness for a first line. As discussed above, the first line may be associated with a respiratory component. For example, the first line may outline the airway. The thickness of the first line may reflect a value for a ventilatory parameter. For example, the thickness of the first line may reflect a measured resistance value. Once the user interface has been displayed, flow proceeds to operation 704.

At operation 704, the ventilator monitors one or more parameters. These parameters may be associated with the parameters displayed on the user interface. For example, the ventilator may monitor resistance, compliance, and respiratory muscle pressure. In addition to measuring respiratory parameters, the ventilator may also measure the onset or cessation of an event. For example, the ventilator may monitor when an aerosol treatment is administered to a patient. Flow then proceeds to operation 708.

At operation 706, a determination is made as to whether a change in a parameter associated with the first line has been detected. Using the example discussed above, the first line may be associated with the airway and the thickness of the first line may reflect a measured resistance value. The ventilator may determine whether this measured resistance value has changed. In one embodiment, this determination may be made on an hourly basis. However, as discussed above, any period of measurement is contemplated within the scope of the present application. Additionally, a determination may be made as to whether an event has been detected. If a determination is made that the value of the measured parameter has not changed, or that an event has not been detected, flow proceeds to operation 704. If a determination is made that the value of the measured parameter has changed, or that an event has been detected, flow proceeds to operation 708.

At operation 708, the user interface is updated based on the changed parameter. Using the example discussed above, the user interface may be updated to reflect an increase or decrease in measured resistance. The increase or decrease in measured resistance may be reflected in a thickening or thinning of the first line. Additionally, the user interface may be updated to reflect detection of an event. For example, the user interface may be updated to depict an event marker indicating that an aerosol treatment has been administered. Once the user interface has been updated, flow proceeds to operation 710.

At operation 710, the user interface is displayed with a new thickness for the first line. Using the example discussed above, the user interface may display a thicker first line to indicate that resistance has increased. The user interface may also display an event. For example, the user interface may display an event marker to indicate that aerosol treatment has been administered. Flow then proceeds to monitor operation 704.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternative embodiments having fewer than or more than all of the features herein described are possible.

While various embodiments have been described for purposes of this disclosure, various changes and modifications may be made which are well within the scope of the present invention. Numerous other changes may be made which will readily suggest themselves to those skilled in the art and which are encompassed in the spirit of the disclosure and as defined in the appended claims.

What is claimed is:

1. A graphical user interface for displaying trend history of a patient's condition on a ventilator configured with a computer having a display for accepting commands and for displaying information including the user interface, the user interface comprising:
at least one window associated with the user interface; and
one or more elements within the at least one window comprising one or more of:
a respiratory system element, depicted by one or more component elements of the respiratory system;
each component element of the one or more component elements further comprising at least one line outlining the components, wherein thickness of the line corresponds to a numeric value of at least one ventilatory parameter.

2. The graphical user interface of claim 1, wherein at least one component element comprises:
a first line having a thickness corresponding to a predetermined reference value of a first ventilatory parameter; and
a second line, adjacent to the first line, having a thickness corresponding to a measured value of the first ventilatory parameter.

3. The graphical user interface of claim 1, wherein an increased thickness of the second line corresponds to an increase in the measured value of the ventilatory parameter.

4. The graphical user interface of claim 2, wherein a decreased thickness of the second line corresponds to a decrease in the measured value of the ventilatory parameter.

5. The graphical user interface of claim 2, further comprising a parameter display icon that corresponds to a selected independent variable.

6. The graphical user interface of claim 5, wherein the measured value of the ventilatory parameter is a function of the selected independent variable.

7. The graphical user interface of claim 6, wherein the independent variable is time.

8. The graphical user interface of claim 1, further comprising an event marker indicating that a patient has undergone a treatment, procedure, or change in therapy

9. The graphical user interface of claim 8, wherein the event marker includes a graphical depiction of an event associated with the event marker and its relation to the independent variable.

10. A computer-readable storage medium having instructions that when executed provide a graphical user interface for displaying trend history of a patient's condition, the graphical user interface comprising:
at least one window associated with the user interface; and
one or more elements within the at least one window comprising one or more of:
a respiratory system element, depicted by one or more component elements of the respiratory system;
each component element of the one or more component elements further comprising at least one line outlining the components, wherein thickness of the line corresponds to a numeric value of at least one ventilatory parameter

11. The graphical user interface of claim 10, wherein at least one component element comprises:
a first line having a thickness corresponding to a predetermined reference value of a first ventilatory parameter; and
a second line, adjacent to the first line, having a thickness corresponding to a measured value of the first ventilatory parameter.

12. The graphical user interface of claim 10, wherein an increased thickness of the second line corresponds to an increase in the measured value of the ventilatory parameter.

13. The graphical user interface of claim 10, wherein a decreased thickness of the second line corresponds to a decrease in the measured value of the ventilatory parameter.

14. The graphical user interface of claim 10, further comprising a parameter display icon that corresponds to a selected independent variable.

15. A method for animating patient trend history on a graphical user interface on a ventilator configured with a computer having a display for accepting commands and for displaying information the method comprising:
displaying a graphical user interface with an original thickness for a first line;
monitoring one or more ventilatory parameters;
detecting a change in a ventilatory parameter associated with the first line;
updating the graphical user interface; and
displaying the graphical user interface with a new thickness for the first line.

16. The method of claim 15, further comprising monitoring the onset and cessation of one or more events.

17. The method of claim 18, further comprising detecting the onset or cessation of an event.

18. The method of claim 19, further comprising displaying the graphical user interface with an indication of the event.

19. The method of claim 17, wherein the first line is associated with a respiratory component.

20. The method of claim 17, wherein the thickness reflects a value of the ventilatory parameter.
